(19) United States
(12) Patent Application Publication
(10) Pub. No.: US 2020/0048534 A1
(43) Pub. Date: Feb. 13, 2020

(54) Breaker Fluids and Methods of Use Thereof

(71) Applicant: M-I L.L.C., Houston, TX (US)

(72) Inventors: Balakrishnan Panamarathupalayam, Houston, TX (US); Richard Toomes, Houston, TX (US); Daniel Alvarez, Houston, TX (US)

(73) Assignee: Shrieve Chemical Products, Inc., The Woodlands, TX (US)

(21) Appl. No.: 16/476,395

(22) PCT Filed: Jan. 6, 2017
(86) PCT No.: PCT/US2017/012596

§ 371 Date: Jul. 8, 2019

(51) Int. Cl. C09K 8/68; C09K 8/72; C09K 8/66; E21B 37/00

(52) U.S. Cl. CPC C09K 8/68; C09K 8/72; E21B 21/003; E21B 37/00; C09K 2208/26; C09K 8/665

(57) ABSTRACT

A breaker fluid includes a base fluid; lactide; and a mixture of hydrolyzable esters of dicarboxylic acids. A method of breaking a filtercake in a wellbore includes circulating a breaker fluid into the wellbore, the breaker fluid including: a base fluid; lactide; and a mixture of hydrolyzable esters of dicarboxylic acids.

### BACKGROUND

During the drilling of a wellbore, various fluids are typically used in the well for a variety of functions. The fluids may be circulated through a drill pipe and drill bit into the wellbore, and then may subsequently flow upward through the wellbore to the surface. During this circulation, the drilling fluid may act to remove drill cuttings from the bottom of the hole to the surface, to suspend cuttings and weighting material when circulation is interrupted, to control subsurface pressures, to maintain the integrity of the wellbore until the well section is cased and cemented, to isolate the fluids from the subterranean formation by providing sufficient hydrostatic pressure to prevent the ingress of formation fluids into the wellbore, to cool and lubricate the drill string and bit, and/or to maximize penetration rate.

One way of protecting the formation is by forming a filtercake on the surface of the subterranean formation. Filtercakes are forming when particles suspended in a wellbore fluid coat and plug the pores in the subterranean formation such that the filtercake prevents or reduce both the loss of fluids into the formation and the influx of fluids present in the formation. A number of ways of forming filtercakes are known in the art, including the use of bridging particles, cuttings created by the drilling process, polymeric additives, and precipitates. Fluid loss pills may also be used where a viscous pill comprising a polymer may be used to reduce the rate of loss of a wellbore fluid to the formation through its viscosity

Upon completion of drilling, the filtercake and/or fluid loss pill may stabilize the wellbore during subsequent completion operations such as placement of a gravel pack in the wellbore. Additionally, during completion operations, when fluid loss is suspected, a fluid loss pill of polymers may be spotted into to reduce or prevent such fluid loss by injection of other completion fluids behind the fluid loss pill to a position within the wellbore which is immediately above a portion of the formation where fluid loss is suspected. Injection of fluids into the wellbore is then stopped, and fluid loss will then move the pill toward the fluid loss location.

After any completion operations have been accomplished, removal of filtercake (formed during drilling and/or completion) remaining on the sidewalls of the wellbore may be necessary. Although filtercake formation and use of fluid loss pills are essential to drilling and completion operations, the barriers can be a significant impediment to the production of hydrocarbon or other fluids from the well if, for example, the rock formation is still plugged by the barrier. Because the filtercake is compact, it often adheres strongly to the formation and may not be readily or completely flushed out of the formation by fluid action alone.

The problems of efficient well clean-up and completion are a significant issue in all wells, and especially in open-hole horizontal well completions. The productivity of a well is somewhat dependent on effectively and efficiently removing the filtercake while minimizing the potential of water blocking, plugging, or otherwise damaging the natural flow channels of the formation, as well as those of the completion assembly.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a breaker fluid that includes a base fluid; lactide; and a mixture of hydrolyzable esters of dicarboxylic acids.

In another aspect, embodiments disclosed herein relate to a method of breaking a filtercake in a wellbore, the method including circulating a breaker fluid into the wellbore, the breaker fluid including: a base fluid; lactide; and a mixture of hydrolyzable esters of dicarboxylic acids.

In yet another aspect, embodiments disclosed herein relate to a breaker fluid, that includes a base fluid; lactide; and a solubility modifier selected from polyols, glycols, glycol ethers, or polyglycols.

In yet another aspect, embodiments disclosed herein relate to a method of breaking a filtercake in a wellbore, the method including circulating a breaker fluid into the wellbore, the breaker fluid including a base fluid; lactide; and a solubility modifier selected from polyols, glycols, glycol ethers, or polyglycols.

Other aspects and advantages of the claimed subject matter will be apparent from the following description and the appended claims.

### DETAILED DESCRIPTION

In one aspect, embodiments disclosed herein are generally directed to chemical breaker and displacement fluids that are useful in the drilling, completing, and working over of subterranean wells, preferably oil and gas wells. In another aspect, embodiments disclosed herein are generally directed to the formulation of a breaker fluid. Specifically, embodiments of breaker fluids may contain one or more hydrolysable esters of organic acids.

The removal of water-based filtercake has been conventionally achieved with water based treatments that include: an aqueous solution with an oxidizer (such as persulfate), a hydrochloric acid solution, organic (acetic, formic) acid, combinations of acids and oxidizers, and aqueous solutions containing enzymes. Chelating agents (e.g., ethylenediaminetetraacetic acid (EDTA)) have also been used to promote the dissolution of calcium carbonate present in the filtercake. According to traditional teachings, the oxidizer and enzyme attack the polymer fraction of the filtercake and the acids and chelating agents typically attack the carbonate fraction (and other minerals) which may be used as bridging particles in the filtercake.

One of the most problematic issues facing filtercake removal involves the formulation of the clean-up or breaker fluid solutions that are both effective and stable. For example, one of the more common components in a filtercake is calcium carbonate, and a clean-up or breaker fluid solution would ideally include hydrochloric acid, which reacts very quickly with calcium carbonate bridging particles. However, while effective in targeting calcium carbonate bridging particles, such a strong acid is also reactive with any calcium carbonate in the formation (e.g., limestone), and it may be reactive or chemically incompatible with other desirable components of the clean-up solution. Further the clean-up or breaker fluid solution can penetrate into the formation, resulting in unanticipated losses, and damage to the formation that subsequently result in only a partial clean-up or loss of well control.

Unintended side effects can also arise from combining the various chemicals used to form the clean-up solutions and using these solutions downhole to remove filtercakes. One such side effect is precipitation in the wellbore, particularly when divalent ions are present in either the breaker fluid or the filtercake. When precipitants form in the wellbore, they can clog the pumps and equipment intended to circulate the fluids and remove the filtercake. For example, various calcium salts may form a precipitate in the processes for removing filtercakes. While precipitation is just one example, the chemical compatibility of the components commonly used in breaker fluids may be less than ideal and can lead to a sudden and unforeseen breakdown in fluid properties before or during a wellbore operation. Accordingly, effective and stable clean up solutions or breaker fluids are highly sought after for efficient wellbore operations.

In one or more embodiments, breaker fluids may include hydrolysable esters of organic acids. Generally, hydrolysable esters that may hydrolyze to release an organic (or inorganic) acid may be used, including, for example, hydrolyzable esters of a C₁ to C₆ carboxylic acid (including hydroxyl or alkoxy carboxylic acids and/or di- or poly-carboxylic acids) and/or a C₁ to C₃₀ mono- or poly-alcohol. In one or more embodiments, one or more hydrolysable esters of a dicarboxylic acid, such as a C₃ to C₈ dicarboxylic acid, may be used in the breaker fluid. Thus, it is also envisioned that mixtures of hydrolyzable esters of dicarboxylic acids may be used. In one or more embodiments, the mixtures of hydrolysable esters of dicarboxylic acids may contain C₃ to C₈ dicarboxylic acids. In one or more embodiments, the mixture of hydrolyzable esters of dicarboxylic acids may include about 57-67 wt. % dimethyl glutarate, 18-28 wt. % dimethyl succinate, and 8-22 wt. % dimethyl adipate.

In one or more embodiments, lactide, a cyclic diester of lactic acid, may be added to the breaker fluid as a hydrolysable ester. In one or more embodiments, lactide may be used in combination with a mixture of dicarboxylic acid esters in a breaker fluid. In one or more embodiments, the mixture of dicarboxylic acid esters and lactide may contain from 10-99 wt. % dicarboxylic acid esters and from 1 to 90 wt. % lactide. In particular embodiments, a mixture of hydrolysable esters may be used in the breaker fluid where the mixture includes about 50 wt. % lactide, about 27-34 wt. % dimethyl glutarate, about 9-14 wt. % dimethyl succinate, and 4-11 wt. % dimethyl adipate. In addition to these hydrolysable carboxylic esters, hydrolysable phosphonic or sulfonic esters could be utilized, such as, for example, R¹H₂PO₃, R¹R²HPO₃, R¹R²R³PO₃, R¹HSO₃, R¹R²SO₃, R¹H₂PO₄, R¹R²HPO₄, R¹R²R³PO₄, R¹HSO₄, or R¹R²SO₄, where R¹, R², and R³ are C₂ to C₃₀ alkyl-, aryl-, arylalkyl-, or alkylaryl-groups.

However, the present inventors have found that the solubility of the dicarboxylic acid esters and/or lactide may depend upon the conditions including type of brine being used as the base fluid for the breaker fluid. That is, the maximum solubility of each component may vary among, for example, divalent and monovalent brines. In some embodiments, a glycol ether such as those formed from C1-C6 alcohols and C2-12 glycols including, but not limited to, dipropylene glycol methyl ether, hexylene glycol methyl ether, ethylene glycol monobutyl ether (EGMBE), and triethylene glycol monobutyl ether (TEGMBE) may be added to the breaker fluid as a solubility modifier. It is also envisioned that a polar organic solvent component, which may be a mono-hydric, di-hydric or poly-hydric alcohol or a mono-hydric, di-hydric, or poly-hydric alcohol having poly-functional groups, may be used as a solubility modifer. Examples of such compounds include aliphatic diols (i.e., glycols, 1,3-diols, 1,4-diols, etc.), aliphatic poly-ols (i.e., tri-ols, tetra-ols, etc.), polyglycols (i.e., polyethylenepropylene glycols, polypropylene glycol, polyethylene glycol, etc.). When included, the solubility modifier may be about 50 to 90 wt. % of the total weight of esters and solubility modifier in the breaker fluid. For example, a breaker fluid may include a component that is a combination of 10 to 50 wt. % lactide and 50-90 wt. % solubility modifier or a component that is a combination of 10 to 30 wt. % dicarboxylic acid esters, 10 to 50 wt. % lactide, and 20 to 80 wt. % solubility modifier. Esters, whether used alone or in combination with a solubility modifier, may be added to a breaker fluid in an amount that ranges from 5 to 50 vol % of the breaker fluid or from 10 to 40 vol % in more particular embodiments. It is understood that when a solubility modifier is used, the combined ester and solubility modifier may be added to the breaker fluid in the amount that ranges from 5 to 50 vol % of the breaker fluid.

In some instances, it may also be desirable to include an oxidant in the breaker fluid, to further aid in breaking or degradation of polymeric additives present in a filter cake. The oxidants may be used with a coating to delay their release or they may be used without a coating. Examples of such oxidants may include any one of those oxidative breakers known in the art to react with polymers such as polysaccharides to reduce the viscosity of polysaccharide-thickened compositions or disrupt filter cakes. Such compounds may include bromates, peroxides (including peroxide adducts), other compounds including a peroxy bond such as persulfates, perborates, percarbonates, perphosphates, and persilicates, and other oxidizers such as hypochlorites. In one or more embodiments, the oxidant may be included in the breaker fluid in an amount from about 1 ppb to 10 ppb. Further, use of an oxidant in a breaker fluid, in addition to affecting polymeric additives, may also cause fragmentation of swollen clays, such as those that cause bit balling.

In one or more embodiments, the breaker fluids of the present disclosure may also be formulated to contain an acid to decrease the pH of the breaker fluid and aid in the degradation of filter cakes within the wellbore. Examples of acids that may be used as breaker fluid additives include strong mineral acids, such as hydrochloric acid or sulfuric acid, and organic acids, such as citric acid, salicylic acid, lactic acid, malic acid, acetic acid, and formic acid. Suitable organic acids that may be used as the acid sources may include citric acid, salicylic acid, glycolic acid, malic acid, maleic acid, fumaric acid, and homo- or copolymers of lactic acid and glycolic acid as well as compounds containing hydroxy, phenoxy, carboxylic, hydroxycarboxylic or phenoxycarboxylic moieties. When included, the acid may be from about 5% to 20% by volume of the breaker fluid.

In one or more embodiments, the breaker fluid may contain chelants to help dissolve precipitates or other solids present in the filtercake. Chelating agents suitable for use in the breaker fluids of the present disclosure may include polydentate chelating agents such as ethylenediaminetetraacetic acid (EDTA), diethylenetriaminepentaacetic acid (DTPA), nitrilotriacetic acid (NTA), ethylene glycol-bis(2-aminoethyl)-N,N,N′,N′-tetraacetic acid (EGTA), 1,2-bis(o-aminophenoxy)ethane-N,N,N′,N′-tetraaceticacid (BAPTA), cyclohexanediaminete-traacetic acid (CDTA), triethylenetetraaminehexaacetic acid (TTHA), N-(2-Hydroxyethyl)ethylenediamine-N,N′,N′-triacetic acid (HEDTA), glutamic-N,N-diacetic acid (GLDA), ethylene-diamine tetra-methylene sulfonic acid (EDTMS), diethylene-triamine penta-methylene sulfonic acid (DETPMS), amino tri-methylene sulfonic acid (ATMS), ethylene-diamine tetra-methylene phosphonic acid (EDTMP), diethylene-triamine penta-methylene phosphonic acid (DETPMP), amino tri-methylene phosphonic acid (ATMP), and mixtures thereof. Such chelating agents may include potassium or sodium salts thereof in some embodiments. Particular examples of chelants that may be employed in certain embodiments include ethylenediaminetetraacetic acid (EDTA), glutamic acid diacetic acid (GLDA) (such as L-glutamic acid, N, N-diacetic acid) iminodiacetic acids and/or salts thereof. A commercially available example of chelants that may be used in breaker fluid formulations is D-SOLVER EXTRA, available from MI-LLC (Houston, Tex.). When included, chelants may be from about 5-20% by volume of the breaker fluid.

In general, the base fluid of a breaker fluid may be may be an aqueous medium selected from water or brine. In those embodiments of the disclosure where the aqueous medium is a brine, the brine is water comprising an inorganic salt or organic salt. The salt may serve to provide desired density to balance downhole formation pressures. In various embodiments of the breaker fluid disclosed herein, the brine may include seawater, aqueous solutions wherein the salt concentration is less than that of sea water, or aqueous solutions wherein the salt concentration is greater than that of sea water. Salts that may be found in seawater include, but are not limited to, sodium, calcium, aluminum, magnesium, zinc, potassium, strontium, and lithium, salts of chlorides, bromides, carbonates, iodides, chlorates, bromates, formates, nitrates, oxides, phosphates, sulfates, silicates, and fluorides. Salts that may be incorporated in a brine include any one or more of those present in natural seawater or any other organic or inorganic dissolved salts.

In some embodiments, the base fluid for the breaker may be a brine that includes a divalent halide that is selected from the group of alkaline earth halides or zinc halides. The brine may also comprise an organic salt, such as sodium, potassium, or cesium formate. Inorganic divalent salts include calcium halides, such as calcium chloride or calcium bromide. Sodium bromide, potassium bromide, or cesium bromide may also be used. The salt may be chosen for compatibility reasons, i.e. where the reservoir drilling fluid used a particular brine phase and the breaker fluid brine phase is chosen to have the same brine phase.

It should be appreciated that the amount of delay between the time when a breaker fluid according to the present disclosure is introduced to a well and the time when the fluids have had the desired effect of breaking/degrading/dispersing the filter cake may depend on several variables. One of skill in the art should appreciate that factors such as the downhole temperature, concentration of the components in the breaker fluid, pH, amount of available water, filter cake composition, etc. may all have an impact. For example downhole temperatures can vary considerably from 100° F. to over 400° F. depending upon the formation geology and downhole environment. However, one of skill in the art via trial and error testing in the lab should easily be able to determine and thus correlate downhole temperature and the time of efficacy of for a given formulation of the breaker fluids disclosed herein. With such information one can predetermine the time period necessary to shut-in a well given a specific downhole temperature and a specific formulation of the breaker fluid.

Breaker fluids in embodiments of this disclosure be emplaced in the wellbore using conventional techniques known in the art, and may be used in drilling, completion, workover operations, etc. Additionally, one skilled in the art would recognize that such wellbore fluids may be prepared with a large variety of formulations. Specific formulations may depend on the stage in which the fluid is being used, for example, depending on the depth and/or the composition of the formation. Moreover, one skilled in the art would also appreciate that other additives known in the art may be added to the breaker fluids of the present disclosure without departing from the scope of the present disclosure.

The types of filtercakes that the present breaker fluids may break include those formed from oil-based or water-based drilling fluids, but particularly water-based drilling fluids including reservoir drill-in fluids. That is, the filtercake may be either an oil-based filter cake (such as an invert emulsion filter cake produced from a fluid in which oil is the external or continuous phase) or a water-based (such as an aqueous filtercake in which water or another aqueous fluid is the continuous phase). It is also within the scope of the present disclosure that filtercakes may also be produced with direct emulsions (oil-in-water), or other fluid types. Additionally, the present breaker fluids may be particularly useful for breaking filtercakes that contain synthetic polymers, including crosslinked and branched synthetic polymers that are often not able to be broken by conventional breaker fluid formulations. However, the breakers may also be effective in breaking fluids/filtercakes formed with conventional polymers used in water-based fluids, such as xanthan and starches.

As described above, the breaker fluid may be circulated in the wellbore during or after the performance of at least one completion operation. In other embodiments, the breaker fluid may be circulated either after a completion operation or after production of formation fluids has commenced to destroy the integrity of and clean up residual drilling fluids remaining inside casing or liners.

Generally, a well is often “completed” to allow for the flow of hydrocarbons out of the formation and up to the surface. As used herein, completion processes may include one or more of the strengthening the well hole with casing, evaluating the pressure and temperature of the formation, and installing the proper completion equipment to ensure an efficient flow of hydrocarbons out of the well or in the case of an injector well, to allow for the injection of gas or water. Completion operations, as used herein, may specifically include open hole completions, conventional perforated completions, sand exclusion completions, permanent completions, multiple zone completions, and drainhole completions, as known in the art. A completed wellbore may contain at least one of a slotted liner, a predrilled liner, a wire wrapped screen, an expandable screen, a sand screen filter, an open hole gravel pack, or casing, for example.

Breaker fluids as disclosed herein may also be used in a cased hole to remove any drilling fluid left in the hole during any drilling and/or displacement processes. Well casing may consist of a series of metal tubes installed in the freshly drilled hole. Casing serves to strengthen the sides of the well hole, ensure that no oil or natural gas seeps out of the well hole as it is brought to the surface, and to keep other fluids or gases from seeping into the formation through the well. Thus, during displacement operations, typically, when switching from drilling with an oil-based mud to a water-based mud (or vice-versa), the fluid in the wellbore is displaced with a different fluid. For example, an oil-based mud may be displaced by another oil-based displacement fluid to clean the wellbore. The oil-based displacement fluid may be followed with a water-based displacement fluid prior to beginning drilling or production. Conversely, when drilling with a water-based mud, prior to production, the water-based mud may be displaced with a water-based displacement fluid, followed with an oil-based displacement fluid. Further, one skilled in the art would appreciate that additional displacement fluids or pills, such as viscous pills, may be used in such displacement or cleaning operations as well, as known in the art.

Another embodiment of the present disclosure involves a method of cleaning up a wellbore drilled with an oil based drilling fluid. In one such illustrative embodiment, the method involves circulating a breaker fluid disclosed herein in a wellbore, and then shutting in the well for a predetermined amount of time to allow penetration and fragmentation of the filtercake to take place. Upon fragmentation of the filtercake, the residual drilling fluid may be easily washed out of the wellbore. Alternatively, a wash fluid (different from the breaker fluid) may be circulated through the wellbore prior to commencing production.

Yet another embodiment of the present invention involves a method of cleaning up a well bore drilled with a water-based drilling fluid, described above. In one such illustrative embodiment, the method involves circulating a breaker fluid disclosed herein in a wellbore and then shutting in the well for a predetermined amount of time to allow penetration and fragmentation of the filter cake to take place. Upon fragmentation of the filter cake, the fluid (and residual filter cake dispersed therein) can be easily produced from the well bore upon initiation of production and thus the residual drilling fluid is easily washed out of the well bore. Alternatively, a wash fluid (different from the breaker fluid) may be circulated through the wellbore prior to commencing production.

The fluids disclosed herein may also be used in a wellbore where a screen is to be put in place downhole. After a hole is under-reamed to widen the diameter of the hole, the drilling string may be removed and replaced with production tubing having a desired sand screen. In one or more embodiments, an expandable tubular sand screen may be expanded in place or a gravel pack may be placed in the well. Breaker fluids may then be placed in the well, and the well is then shut in to allow penetration and fragmentation of the filtercake to take place. Upon fragmentation of the filtercake, the fluids can be easily produced from the well bore upon initiation of production and thus the residual drilling fluid is easily washed out of the well bore. In one or more embodiments, a wash fluid (different from the breaker fluid) may be circulated through the wellbore prior to commencing production.

However, the breaker fluids disclosed herein may also be used in various embodiments as a displacement fluid and/or a wash fluid. As used herein, a displacement fluid is typically used to physically push another fluid out of the wellbore, and a wash fluid typically contains a surfactant and may be used to physically and chemically remove drilling fluid residue from downhole tubulars. When also used as a displacement fluid, the breaker fluids of the present disclosure may act to effectively push or displace the drilling fluid. When also used as a wash fluid, the breaker fluids may assist in physically and/or chemically removing the filter cake once the filter cake has been disaggregated by the breaker system.

Further, in some embodiments, the breaker fluids of the present disclosure may be used in wells that have been gravel packed. For example, as known to those skilled in the art, gravel packing involves pumping into the well (and placing in a production interval) a carrier fluid (conventionally a viscoelastic fluid) that contains the necessary amount of gravel to prevent sand from flowing into the wellbore during production. However, filter cake remaining on the walls and the viscoelastic carrier fluid should be removed prior to production. In a particular embodiment, after placement of a gravel pack, a breaker fluid of the present disclosure may be emplaced in the production interval and allowed sufficient time to decrease the viscosity of the viscoelastic carrier fluid and then penetrate and fragment filter cake in the interval, as described above. Alternatively, a wash fluid may be used following the placement of the gravel pack, but prior to the emplacement of the breaker fluid.

### EXAMPLES

### Example 1—Solubility Test

The solubility of lactide and/or mixtures of dicarboxylic acid esters was tested in brines. The results of the solubility tests are presented in Table 1 below. The mixture of dicarboxylic acid esters included about 57-67 wt. % dimethyl glutarate, 18-28 wt. % dimethyl succinate, and 8-22 wt. % dimethyl adipate

TABLE 1

| Composition (wt. %) | Solubility/Dissolution |
|---|---|
| 50% Lactide | Initial Solubility: ZnBr₂, |
| 50% mixture of dicarboxylic acid esters | CaBr₂ (partial) |
| 50% Lactide | Initial Solubility: ZnBr₂, |
| 50% dipropylene glycol monomethyl ether | CaBr₂ (partial), |
| | NaBr (partial) |
| 33.3% Lactide | Initial Solubility: ZnBr₂, |
| 66.67% dipropylene glycol monomethyl ether | CaBr₂, NaBr, CaCl₂ |
| 25% Lactide | Initial Solubility: ZnBr₂, |
| 75% dipropylene glycol monomethyl ether | CaBr₂ (partial), |
| | NaBr₂ (partial) |
| 16.67% Lactide | Initial Solubility: ZnBr₂, |
| 16.67% mixture of dicarboxylic acid esters | CaBr₂ (partial) |
| 66.66% dipropylene glycol monomethyl ether | |

### Example 2—Clean Up Efficiency

Two breaker fluids were formulated using ECF-1872, available from MI-LLC (Houston, Tex.) which includes about 33.3 wt. % lactide and 66.7 wt. % dipropylene glycol monomethyl ether. These breaker fluids were tested for their ability to break filtercakes formed by FLO-PRO, a water based drilling fluid that contains xanthan gum and is available from MI-LLC (Houston, Tex.), and DIPRO, a water based drilling fluid that contains starch and is available from MI-LLC (Houston, Tex.). D-SOLVER EXTRA is a brine soluble chelating agent available from MI-LLC (Houston, Tex.). The breaker formulation and results obtained after soaking for 72-96 hours are shown in Table 2 below. Flowback testing was used to quantify the removal efficiency along with standard visual analysis.

| Initial | Soak | | Visual | Flow |
|---|---|---|---|---|
| Filtercake | Temp | Breaker Formulation | Removal | Back % |
| FLOPRO | 150° F. | 10.39 ppg NaBr | Yes | 84% Inj. |
| | | 20%/vol ECF-1872 | | 95% Prod. |
| | | 10%/vol DSOLVER | | |
| | | EXTRA | | |
| DIPRO | 150° F. | −12.4ppg CaBr2 | Yes | 92% Inj. |
| | | −25%/vol ECF-1872 | | 97% Prod. |
| | | −10%/vol DSOLVER | | |
| | | EXTRA | | |

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed:

1. A breaker fluid, comprising:
a base fluid;
lactide; and
a mixture of hydrolyzable esters of dicarboxylic acids.

2. The breaker fluid of claim 1, wherein the mixture of hydrolysable esters of dicarboxylic acids contains C₃ to C₈ dicarboxylic acids.

3. The breaker fluid of claim 1, wherein the mixture of hydrolysable esters of dicarboxylic acids includes about 57-67 wt. % dimethyl glutarate, 18-28 wt. % dimethyl succinate, and 8-22 wt. % dimethyl adipate.

4. The breaker fluid of claim 1, wherein relative to the total amount of lactide and the mixture of hydrolysable dicarboxylic acid esters in the breaker fluid, the mixture of hydrolysable dicarboxylic acid esters forms about 10-99 wt. %, and lactide forms about 1 to 90 wt. %.

5. The breaker fluid of claim 1, further comprising an acid.

6. The breaker fluid of claim 1, further comprising an oxidant.

7. The breaker fluid of claim 1, wherein the base fluid is a brine that includes divalent halides selected from alkaline earth halides or zinc halides.

8. The breaker fluid of claim 1, further comprising a solubility modifier selected from polyols, glycols, glycol ethers, or polyglycols.

9. A method of breaking a filtercake in a wellbore, the method comprising:
circulating a breaker fluid into the wellbore, the breaker fluid comprising:
a base fluid;
lactide; and
a mixture of hydrolyzable esters of dicarboxylic acids.

10. The method of claim 9, wherein relative to the total amount of lactide and the mixture of hydrolysable dicarboxylic acid esters in the breaker fluid, the mixture of hydrolysable dicarboxylic acid esters forms about 10-99 wt. %, and lactide forms about 1 to 90 wt. %.

11. A breaker fluid, comprising:
a base fluid;
lactide; and
a solubility modifier selected from polyols, glycols, glycol ethers, or polyglycols.

12. The breaker fluid of claim 11, wherein lactide is present at 10-50 wt. % and the solubility modifier is present at 50-90 wt. %, both relative to the total amount of lactide and solubility modifier.

13. The breaker fluid of claim 11, further comprising an acid.

14. The breaker fluid of claim 11, further comprising an oxidant.

15. The breaker fluid of claim 11, further comprising a mixture of hydrolyzable esters of dicarboxylic acids.

16. The breaker fluid of claim 15, wherein the hydrolysable esters of dicarboxylic acids are present at about 10-30 wt. %, lactide is present at about 10-50 wt. %, and the solubility modifier is present at about 20-80 wt. %, all of which are relative to the total amount of lactide, hydrolysable esters of dicarboxylic acids and solubility modifier in the breaker fluid.

17. The breaker fluid of claim 15, wherein the base fluid comprises a monovalent brine.

18. The breaker fluid of claim 11, wherein the solubility modifier is a glycol ether selected from selected from dipropylene glycol methyl ether, hexylene glycol methyl ether, ethylene glycol monobutyl ether (EGMBE), and triethylene glycol monobutyl ether.

19. A method of breaking a filtercake in a wellbore, the method comprising:
circulating a breaker fluid into the wellbore, the breaker fluid comprising:
a base fluid;
lactide; and
a solubility modifier selected from polyols, glycols, glycol ethers, or polyglycols.

20. The method of claim 19, wherein lactide is present at 10-50 wt. % and the solubility modifier is present at 50-90 wt. %, both relative to the total amount of lactide and solubility modifier.
